(19) United States
(12) Patent Application Publication
(10) Pub. No.: US 2026/0254750 A1
(43) Pub. Date: Aug. 27, 2026

(54) DATA ROUTING METHOD AND DATA ROUTING SYSTEM

(71) Applicant: SAMSUNG ELECTRONICS CO., LTD., Suwon-si (KR)

(72) Inventor: Mun Gyu SON, Suwon-si (KR)

(73) Assignee: SAMSUNG ELECTRONICS CO., LTD., Suwon-si (KR)

(21) Appl. No.: 19/351,798

(22) Filed: Oct. 7, 2025

(30) Foreign Application Priority Data
Feb. 25, 2025 (KR) 10-2025-0024598

(51) Int. Cl. H04L 45/00; H04L 45/122; H04L 45/125; H04L 45/74

(52) U.S. Cl. CPC H04L 45/22; H04L 45/122; H04L 45/125; H04L 45/74

(57) ABSTRACT

A method and system for routing data are provided. For example, the method includes determining a source node to transmit data and a destination node to receive data generated by the source node among a plurality of nodes in the network, acquiring a target region including nodes of a reference region determined based on a shortest path from the source node to the destination node and at least one node outside the reference region, delivering data originating from the source node to a target node selected from candidate intermediate nodes of the target region, and delivering the data originating from the source node to the destination node from the target node.

### CROSS-REFERENCE TO RELATED APPLICATION

This application claims priority from Korean Patent Application No. 10-2025-0024598, filed on Feb. 25, 2025, in the Korean Intellectual Property Office, the entire disclosure of which is incorporated herein by reference for all purposes.

### BACKGROUND

### 1. Field

The disclosure relates to a data routing method and a data routing system.

### 2. Description of the Related Art

In a parallel computing environment, when multiple chips perform a single job simultaneously, collective communication may be required in which an overall process jointly exchanges data. To this end, large-scale nodes included in a network must be efficiently connected. For example, a lattice-based topology such as a mesh or torus may be used to connect the large-scale nodes included in the network. Routing schemes that search a path to deliver a packet from a source node to a destination node via multiple nodes in the network may include oblivious routing that does not consider a network state and adaptive routing that dynamically selects a path. The oblivious routing scheme may include a method of routing via a shortest path from a source node to a destination node, and a method of routing via a predetermined intermediate node.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of the disclosure, there is provided a method of routing data in a network, the method including: determining, from among a plurality of nodes in the network, a source node and a destination node, the source node configured to transmit data and the destination node configured to receive the data from the source node; acquiring a target region including nodes of a reference region, among the plurality of nodes, the reference region determined based on a shortest path from the source node to the destination node and at least one node outside the reference region; transmitting the data originating from the source node to a target node selected from candidate intermediate nodes in the target region; and transmitting the data originating from the source node to the destination node from the target node.

The acquiring of the target region includes: identifying the reference region, based on a position of the source node and the destination node in the network; and acquiring the target region including a path generated based on the at least one node outside the reference region.

The acquiring of the target region includes: in an array in which the plurality of nodes are arranged in a lattice form, determining a node at a first position with respect to the source node to be a first node, based on the source node and the destination node being positioned further inside the array than nodes arranged at an edge of the array; determining a node at a second position with respect to the destination node to be a second node; and acquiring the target region including the first node and the second node.

The acquiring of the target region includes: in an array in which the plurality of nodes are arranged in a lattice form, based on the source node and the destination node being arranged in a row along a first axis direction, determining at least one node among nodes positioned in a second axis direction perpendicular to the first axis direction with respect to the source node to be a first node; determining at least one node among the nodes positioned in the second axis direction with respect to the destination node to be a second node; and acquiring the target region including the first node and the second node.

The acquiring of the target region includes: in an array in which the plurality of nodes are arranged in a lattice form, based on one of the source node or the destination node being positioned at a corner of the array, determining a node positioned at the corner to be a first node; determining a node arranged at a first position other than the node positioned at the corner among the source node or the destination node to be a second node; and acquiring the target region including the first node and the second node.

The acquiring of the target region includes: in an array in which the plurality of nodes are arranged in a lattice form, determining whether at least one of the source node and the destination node is positioned at an edge of the array; based on at least one of the source node and the destination node being positioned at an edge of the array, acquiring a target region smaller than a threshold size; and based on the source node and the destination node being positioned inside the edge of the array, acquiring a target region larger than the threshold size.

The transmitting of the data originating from the source node to the selected target node includes: transmitting information about the target region to the candidate intermediate nodes in the target region; and selecting the target node from the candidate intermediate nodes in the target region, based on the information about the target region.

The selecting of the target node includes: measuring congestions on data movement paths corresponding to each of the candidate intermediate nodes in the target region; and selecting a candidate intermediate node corresponding to a lowest congestion among the measured congestions as the target node.

The determining of the source node and the destination node includes: acquiring address information corresponding to a position of the source node; and acquiring address information corresponding to a position of the destination node.

The transmitting of the data originating from the source node to the target node includes: transmitting the data from the source node to the target node via a first shortest path corresponding to a minimum hop count, and wherein the transmitting of the data from the target node to the destination node includes: transmitting the data from the target node to the destination node via a second shortest path corresponding to a minimum hop count.

The transmitting of the data originating from the source node to the target node includes: determining whether a node to receive the data is positioned inside the target region; and based on the node to receive the data being positioned inside the target region, transmitting the data originating from the source node to the node to receive the data.

According to another aspect of the disclosure, there is provided a non-transitory computer-readable storage medium storing one or more executable program instructions, wherein the one or more executable program instructions, when executed by a computing system, configured to cause the computing system to: determine, from among a plurality of nodes in a network, a source node and a destination node, the source node configured to transmit data and the destination node configured to receive the data from the source node, acquire a target region including nodes of a reference region, among the plurality of nodes, the reference region determined based on a shortest path from the source node to the destination node and at least one node outside the reference region, transmit the data originating from the source node to a target node selected from candidate intermediate nodes in the target region, and transmit the data originating from the source node to the destination node from the target node.

According to another aspect of the disclosure, there is provided a system for routing data, including: a plurality of nodes in a network, wherein at least one node of the plurality of nodes comprises: memory storing a plurality of instructions; a switch; and a processor for executing the plurality of instructions and determining a port to transmit data through the switch, wherein the processor is configured to: determine, from among the plurality of nodes, a source node and a destination node, the source node configured to transmit data and the destination node configured to receive the data from the source node, acquire a target region comprising nodes of a reference region, among the plurality of nodes, the reference region determined based on a shortest path from the source node to the destination node and at least one node outside the reference region, transmit the data originating from the source node to a target node selected from candidate intermediate nodes in the target region, and transmit the data originating from the source node to the destination node from the target node.

The processor is further configured to: identify the reference region, based on a position of the source node and the destination node in the network, and acquire the target region comprising a path generated based on the at least one node outside the reference region.

The processor is further configured to: in an array in which the plurality of nodes are arranged in a lattice form, determine a node at a first position with respect to the source node to be a first node, based on the source node and the destination node being positioned further inside the array than nodes arranged at an edge of the array, determine a node at a second position with respect to the destination node to be a second node, and acquire the target region comprising the first node and the second node.

The processor is further configured to: in an array in which the plurality of nodes are arranged in a lattice form, based on the source node and the destination node being arranged in a row along a first axis direction, determine at least one node among nodes positioned in a second axis direction perpendicular to the first axis direction with respect to the source node to be a first node, determine at least one node among the nodes positioned in the second axis direction with respect to the destination node to be a second node, and acquire the target region comprising the first node and the second node.

The processor is further configured to: in an array in which the plurality of nodes are arranged in a lattice form, based on one of the source node or the destination node being positioned at a corner of the array, determine a node positioned at the corner to be a first node, determine a node arranged at a first position other than the node positioned at the corner among the source node or the destination node to be a second node, and acquire the target region comprising the first node and the second node.

The processor is further configured to: in an array in which the plurality of nodes are arranged in a lattice form, determine whether at least one of the source node and the destination node is positioned at an edge of the array, based on at least one of the source node and the destination node being positioned at an edge of the array, acquire a target region smaller than a predetermined threshold size, and based on the source node and the destination node being positioned inside the edge of the array, acquire a target region larger than the predetermined threshold size.

The processor is further configured to: transmit information about the target region to the candidate intermediate nodes comprised in the target region, and select the target node from the candidate intermediate nodes comprised in the target region, based on the information about the target region.

The processor is further configured to: measure congestions on data movement paths corresponding to each of the candidate intermediate nodes comprised in the target region, and select a candidate intermediate node corresponding to a lowest congestion among the measured congestions as the target node.

Additional aspects of embodiments will be set forth in part in the description which follows and, in part, will be apparent from the description, or may be learned by practice of the disclosure.

### BRIEF DESCRIPTION OF DRAWINGS

The above and/or other aspects will be more apparent by describing certain embodiments with reference to the accompanying drawings, in which:

FIG. 1 is a diagram illustrating a method of routing data between a plurality of nodes included in a network;

FIG. 2 is a schematic flowchart of a method of routing data according to an embodiment;

FIG. 3 is a schematic block diagram illustrating nodes of a system, according to an embodiment;

FIGS. 4 to 7 are diagrams illustrating a method by which each node of a system acquires a target region based on a processor, according to an embodiment; and

FIG. 8 is a diagram illustrating a method of acquiring a target region when a plurality of nodes of a system form a three-dimensional (3D) network structure, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms of “first” or “second” are used to explain various components, the components are not limited to the terms. These terms should be used only to distinguish one component from another component. For example, a first component may be referred to as a second component, and similarly, the second component may also be referred to as the first component.

It will be understood that when a component is referred to as being “connected to” or “coupled” to another component, the component may be directly connected or coupled to the other component or intervening components may be present.

As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and any repeated description related thereto will be omitted.

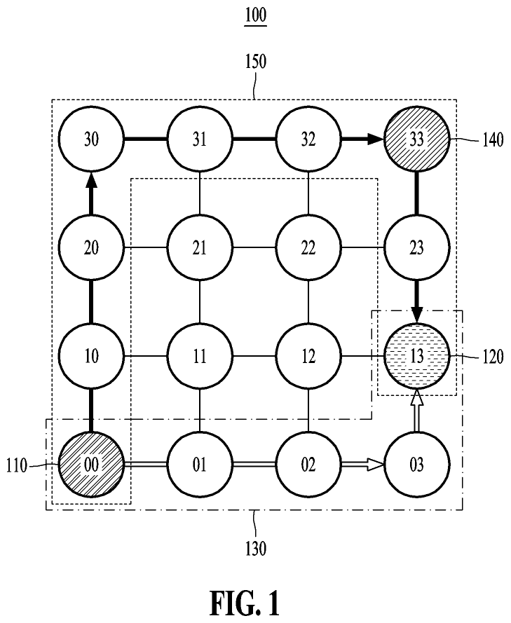

FIG. 1 is a diagram illustrating a method of routing data between a plurality of nodes included in a network.

FIG. 1 illustrates a system 100 including a plurality of nodes according to an embodiment. For example, each of the plurality of nodes may be a chiplet, core, or individual device configured to generate data, deliver data, and/or receive data. The system 100 may perform a method of routing data through a network between the plurality of nodes. For example, in the system 100, the plurality of nodes may deliver data through the network. The system 100 may route data from one of the plurality of nodes to another node. For example, the system 100 may deliver data from a node (e.g., a first node) to another node (e.g., a second node) along a path determined based on various factors of the network. For example, the path between the first node and the second node may be the shortest path. According to an embodiment, the method of delivering data between a plurality of nodes may be implemented based on one or more characteristics of the plurality of nodes in the system (e.g., topology of the system). For example, in the description below, a detailed method of delivering data between a plurality of nodes considering congestion and moving distance (e.g., hop count) between the nodes in the system 100 is provided. A topology that may be formed by the plurality of nodes as a connection relationship between nodes that are considered by the system 100 to determine a path for delivering data between the plurality of nodes is described.

According to an embodiment, each of the plurality of nodes included in the system 100 may be connected to at least one other node. For example, the plurality of nodes included in the system 100 may be connected in a mesh topology of a lattice form. The mesh topology may be a network structure in which a plurality of nodes are arranged in a lattice form and interconnected. Hereinafter, a method of routing data between a plurality of nodes is described, focusing on an example where the plurality of nodes of the system 100 are interconnected in a mesh topology.

Referring to FIG. 1, the system 100 according to an embodiment may include a plurality of nodes forming a network having a 4×4 mesh topology structure. However, the disclosure is not limited thereto, and as such, the number of nodes rows and columns may be different than 4. For example, referring to FIG. 1, the nodes included in the system 100 may be arranged in an i row and j column, respectively. In this example, i and j may be integers greater than or equal to 0 and less than or equal to 4. Each of the plurality of nodes included in the system 100 may have an address that is distinguished by a position of a node in the mesh topology. According to an embodiment, the position of a node may be distinguished based on each row and each column in an array of a network.

According to an embodiment, some nodes in the system 100 may perform operations associated with data routing. For example, a source node 110 that is configured to generate data and a destination node 120 that is configured to receive the data from the source node 110 may be determined among the plurality of nodes. The following is an example in which node 00 is the source node 110 and node 13 is the destination node 120 in the system 100.

For example, the system 100 may route data from the source node 110 to the destination node 120 along a first path 130. The first path 130 may be a shortest distance from the source node 110 to the destination node 120 in the network, and may be a path in which data is routed in a sequence of source node 110-node 01-node 02-node 03-destination node 120. For example, the shortest path may be based on a lowest hop count between the source node and the destination node. The system 100 may deliver data from the source node 110 to the destination node 120 with a total of 4 hop counts. In FIG. 1, an example is illustrated in which the system 100 delivers data from the source node 110 to the destination node 120 via the first path 130, but the system 100 may also route data in a sequence of source node 110-node 10-node 11-node 12-destination node 120. The system 100 may route data by using more of nodes arranged in the center of the network than nodes arranged at the edges of the network. However, in an example case in which routing from node 00 to node 13, as well as routing from node 01 to node 13 and routing from node 02 to node 13 occur in parallel, load unbalance or load overload may occur at node 12. In other words, congestion may increase excessively in at least one node of the first path 130, which may increase routing time from the source node 110 to the destination node 120.

As another example, the system 100 may route data from the source node 110 via an intermediate node 140 along a second path 150 to the destination node 120. The system 100 may route data along a path including source node 110-node 10-node 20-node 30-node 31-node 32-intermediate node 140-node 23-destination node 120. However, the second path 150 may have a total hop count of 8. In other words, routing data through the second path 150 may have higher latency than routing data through the first path 130.

The system 100 according to an embodiment may select the intermediate node 140 to reduce load unbalance, load overload, and routing latency. Hereinafter, a method of setting a region for selecting the intermediate node 140 performed by the system 100 is described in detail.

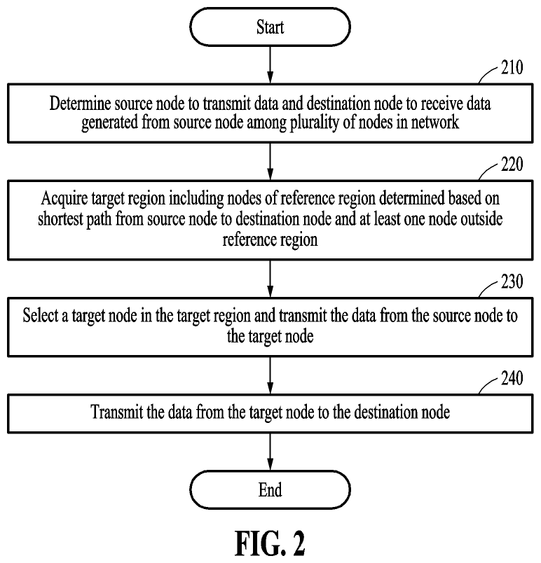

FIG. 2 is a schematic flowchart of a method of routing data according to an embodiment.

A system according to an embodiment may identify a connection relationship between a plurality of nodes arranged in a network. For example, the system may determine whether a plurality of nodes arranged in a network have a mesh topology structure or a torus topology structure. However, this is only an example and the connection relationship between a plurality of nodes is not limited thereto. The following is an example in which the system determines that a plurality of nodes are connected in a mesh topology structure.

In operation 210, the method may include determining a source node and a destination node among a plurality of nodes in a network. For example, the system may determine the source node to generate or transmit data among the plurality of nodes in a network. For example, the system may acquire address information (e.g., node 00 of FIG. 1) corresponding to a position of the source node among the plurality of nodes. For example, the address information of the source node may be determined by a row and column at which the source node is positioned, as illustrated in FIG. 1. However, the disclosure is not limited thereto, and as such, the address information may be determined in another manner. Additionally, the system may determine the destination node to receive the data generated or transmitted from the source node. For example, the system may acquire address information (e.g., node 13 of FIG. 1) corresponding to a position of the destination node among the plurality of nodes. For example, the address information of the destination node may be determined by a row and column at which the destination node is positioned, as illustrated in FIG. 1, but is not limited thereto.

In operation 220, the method may include determining a reference region based on the source node and the destination node. For example, the system may determine the reference region based on a shortest path from the source node to the destination node. For example, in FIG. 1, the system 100 may determine a path that delivers data from the source node 110 to the destination node 120 with a total of 4 hop counts to be the shortest path. For example, in FIG. 1, the system 100 may determine one of the shortest paths from the source node 110 to the destination node 120 to be the first path 130. In FIG. 1, the system 100 may determine the reference region to include paths (e.g., the first path 130) from the source node 110 to the destination node 120 with a total hop count of 4. For example, the system may determine a rectangular region including the source node 110 and the destination node 120 to be the reference region. However, the disclosure is not limited thereto, and as such, the shape of the region may include another shape. For example, expressions referring to geometric shapes or positional relationships used herein may, unless indicated otherwise by the description, represent geometric shapes or positional relationships in a space where an arrangement and connection of nodes in a network are topologically defined.

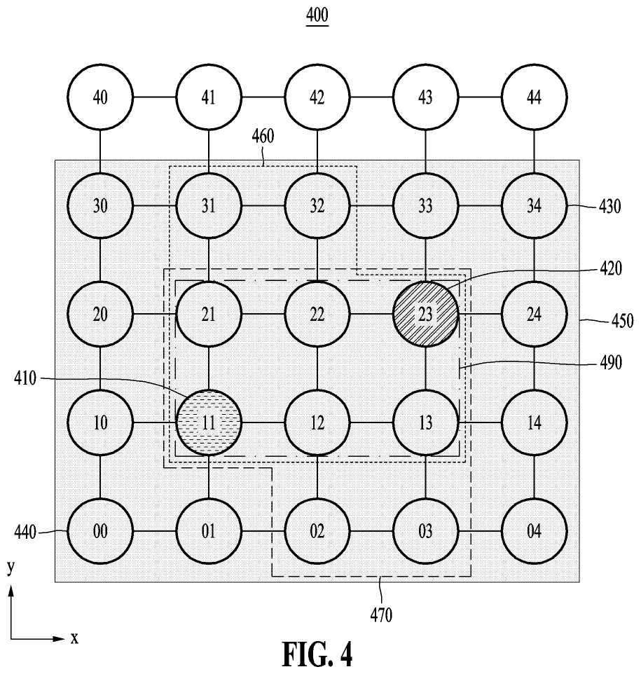

The system may acquire a target region that includes at least one node outside the reference region. For example, the system may acquire a target region to include the reference region. For example, the system may acquire a target region that includes more nodes in a row (or a column) than the reference region. For example, the system may acquire a target region that includes a path generated based on at least one node outside the reference region. For example, the system may acquire a target region that includes a path that deviates from the shortest path from the source node to the destination node based on at least one node outside the reference region. For example, referring to FIG. 1, the system 100 may acquire a target region including a path generated based on nodes included in a rectangular region including the source node 110, the destination node 120, the node 20 and a node 21. The system 100 may acquire, based on node 20 and node 21, a target region including \textcircled{1} a path connecting node 10 and node 20, \textcircled{2} a path connecting node 20 and node 21, and \textcircled{3} a path connecting node 21 and node 11. For example, in an array-structured network in which a plurality of nodes are arranged in a lattice form, the system may acquire a target region based on positions of the source node and destination node in the array. For example, the system may determine whether at least one of the source node or the destination node is positioned at an edge of the array. The system may acquire a target region smaller than a reference size in an example case in which at least one of the source node or the destination node is positioned at an edge of the array. For example, the reference size may be a predetermine threshold size. As another example, the system may determine whether the source node and destination node are positioned inside an edge of the array. The system may acquire a target region larger than the predetermined threshold size in an example case in which the source node and the destination node are positioned inside the edge of the array. For example, the inside of a network with a mesh topology structure may have a greater amount of data movement than the edges. Accordingly, the system may set a wide region in which a target node (e.g., the intermediate node 140 of FIG. 1) is to be selected by acquiring a target region larger than the predetermined threshold size in an example case in which the source node and the destination node are positioned inside the network topology. As another example, the system may narrow a region in which the target node (e.g., the intermediate node 140 of FIG. 1) is to be selected, by acquiring a target region smaller than the predetermined threshold size in an example case in which at least one of the source node and the destination node is positioned at an edge of the network having a mesh topology structure. The method by which the system acquires the target region is described in detail below with reference to FIGS. 4 to 7.

In operation 230, the method may include selecting a target node in the target region and transmitting the data from the source node to the target node. For example, the system may select the target node from among candidate intermediate nodes included in the target region. For example, the system may deliver information about the target region to candidate intermediate nodes included in the target region. The system may select a target node from the candidate intermediate nodes of the target region, based on the delivered information about the target region. For example, the system may measure congestions along data movement paths corresponding to each of the candidate intermediate nodes included in the target region. The system may select a candidate intermediate node corresponding to a lowest congestion among the measured congestions as the target node. However, the method by which the system selects the target node is not limited to the example described above, and the system may select a predetermined node among the candidate intermediate nodes included in the target region as the target node. The system may deliver data originating from the source node to the target node (e.g., the intermediate node 140 of FIG. 1) selected from the candidate intermediate nodes in the target region. The data originating from the source node may be generated from the source node. For example, the system may deliver the data originating from the source node to the destination node along a first shortest path corresponding to a minimum hop count. The method by which the system delivers data from the source node to the target node is described in detail below with reference to FIGS. 4 to 7.

In operation 240, the method may include transmitting the data form the target node to the destination node. For example, the system may deliver the data (which originated from the source node) from the target node to the destination node. For example, the system may deliver data from the target node to the destination node via a second shortest path corresponding to the minimum hop count. The system may determine whether a node to receive the data is positioned inside the target region. In an example case in which the node to receive the data is positioned inside the target region, the system may deliver the data originating from the source node to the node to receive the data. As another example, the system may search for a new node to receive the data based on a determination that the node to receive the data is positioned outside the target region. In this example, the new node may include a node connected to the node to deliver data. The system may also determine whether the new node is positioned inside the target region. The system may deliver data from the source node to the new node based on a determination that the new node is positioned inside the target region.

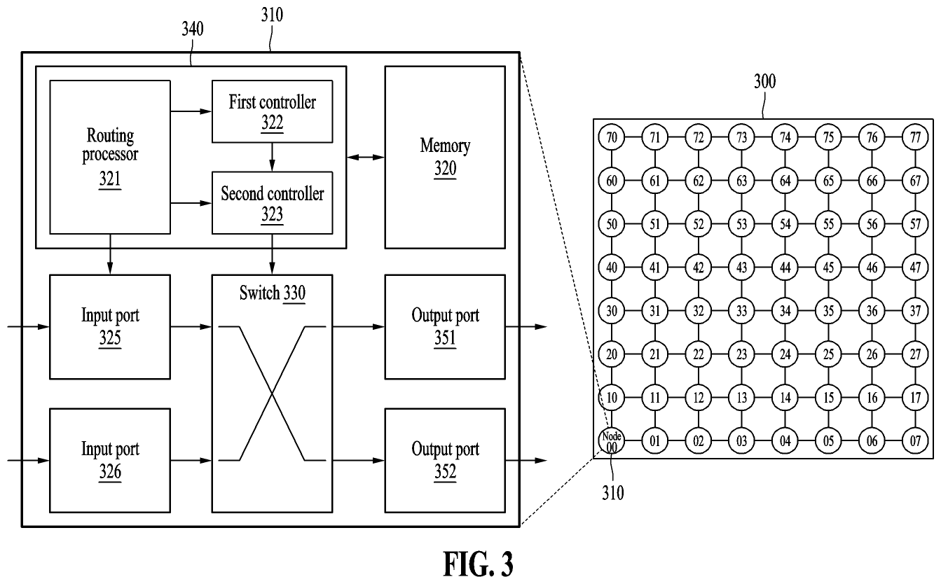

FIG. 3 is a schematic block diagram illustrating nodes of a system, according to an embodiment.

A system 300 according to an embodiment may include a plurality of nodes. The plurality of nodes may form a network having a specific topological structure. For example, the plurality of nodes may be arranged in a lattice shape to form a network having a mesh topological structure. The topological structure that may be formed by the plurality of nodes is not limited to a mesh topological structure, and may include various closed topological structures other than a torus topological structure. According to an embodiment, at least one node 310 among the plurality of nodes may include a memory 320, a plurality of input ports 325 and 326, a switch 330, a processor 340, and a plurality of output ports 351 and 352. For example, the plurality of input ports may include a first input port 325 and the second input port 326, and the plurality of output ports may include a first output port 351 and the second output port 352. However, the disclosure is not limited thereto, and as such, the node 310 may include one or more additional components, omit one or more components, or one or more components may be combined.

The memory 320 may store a plurality of instructions. For example, the memory 320 may store instructions to determine a routing path for data received from other nodes. For example, the memory 320 may store instructions executable by the processor 340. For example, the memory 320 may store information about an interconnection relationship between a plurality of nodes included in the system 300, the topology, and a current position of nodes in the network. For example, the memory 320 may store information corresponding to a structure of a network generated by the plurality of nodes included in the system 300. In an example case in which the plurality of nodes in the system 300 form a network with a mesh topology structure, the memory 320 may store information that a structure of the network based on the plurality of nodes included in the system 300 is a mesh topology structure.

According to an embodiment, the node 310 may receive data from another node through the plurality of input ports 325 and 326. For example, the node 310 may receive data from a first node connected to the node 310 via the first input port 325. For example, the node 310 may receive data from a second node connected to the node 310 via the second input port 326. For example, each node in the system 300 may transmit data in parallel. Accordingly, the node 310 may receive data from the first node through the first input port 325 and simultaneously receive data from the second node through the second input port 326. In FIG. 3, an example is illustrated where there are two input ports 325 and 326 included in the node 310, but the number of the input ports 325 and 326 is not limited thereto, and the number of the input ports 325 and 326 may vary based on a connection relationship of the nodes included in the system 300. In an example case in which a network structure in which nodes in the system 300 are connected has a rectangular lattice form, the number of the input ports 325 and 326 may be 4, and in an example case in which the network structure in which the nodes are connected has a triangular lattice form, the number of the input ports 325 and 326 may be 6.

The switch 330 may deliver data received through the input ports 325 and 326 to the output ports 351 and 352. For example, the switch 330 may deliver data to an output port on a routing path, based on destination node information of the received data. The switch 330 may be controlled by the processor 340.

The processor 340 may execute a plurality of instructions stored in the memory 320. The processor 340 may determine a routing path of the received data based on a routing processor 321. The processor 340 may determine a source node to transmit data and a destination node among the plurality of nodes of the system 300. For example, the processor 340 may extract information about the source node and the destination node based on data received at the input ports 325 and 326. The processor 340 may determine a position of the source node and the destination node in the system 300 and a connection relationship with other nodes, based on the extracted information. The processor 340 may acquire a target region including nodes of a reference region determined based on a shortest path from a source node to a destination node and at least one node outside the reference region. The processor 340 may determine a range of the target region based on a first controller 322. For example, the first controller 322 may change a size of the target region. For example, the first controller 322 may change the size of the target region to be larger (or smaller) than a reference region determined based on the shortest path between the source node and the destination node. The processor 340 may select a target node from candidate intermediate nodes included in the target region. For example, the target node selected by the processor 340 may be a node with the lowest congestion on a path to the target node, but is not limited thereto. The processor 340 may deliver data originating from the source node to the target node included in the target region. The processor 340 may control the switch 330 to determine data to be delivered from an input port (e.g., the input ports 325 and 326) to an output port (e.g., the output ports 351 and 352). For example, the processor 340 may control the switch 330 based on a second controller 323. The second controller 323 may control the switch 330 such that the switch 330 to the output port to which data received at the input ports 325 and 326 is to be delivered is turned on. In an example case in which a node connected to the first output port 351 is closer to the target node than a node connected to the second output port 352, the second controller 323 may turn on the switch 330 to the first output port 351 and turn off the switch 330 to the second output port 352.

Nodes adjacent to the node 310 may be connected to the plurality of output ports 351 and 352, respectively. For example, the node 310 may be connected to a third node adjacent to the node 310 via the first output port 351. For example, the node 310 may be connected to a fourth node adjacent to the node 310 via the second output port 352. In FIG. 3, the node 310 is illustrated as including two output ports 351 and 352, but the number of the output ports 351 and 352 is not limited thereto. In an example case in which four other nodes are connected to the node 310, the number of the output ports 351 and 352 may be four.

In summary, the node 310 may receive data through the input ports 325 and 326 and, using the processor 340, may acquire a target region in the system 300 to select a target node to which to transmit the received data. The node 310 may select a target node in the target region to transmit data through the processor 340. The node 310 may control the switch 330 such that the switch 330 to the output port connected to a node adjacent to the selected target node is turned on, thereby delivering data from the input port to the output port. The node 310 may deliver data to an adjacent node connected to an output port. The adjacent node that has received data from the node 310 may repeat the method of receiving data from the node 310 of FIG. 3 and deliver the data to the next node. As a result, data may be delivered from the source node to the target node and then from the target node to the destination node.

FIGS. 4 to 7 are diagrams illustrating a method by which each node of a system acquires a target region based on a processor, according to an embodiment.

Referring to FIGS. 4 to 7, a plurality of nodes included in a system 400, 500, 600, or 700 may form a network having an N×M mesh topology structure, where N and M are integers greater than or equal to 1. In FIGS. 4 to 7, examples show the plurality of nodes included in the system 400, 500, 600, or 700 forming a network having a 5×5 mesh topology structure. In addition, in order to distinguish target regions of different sizes in FIGS. 4 to 7, the target regions are expressed as first to sixth target regions.

Referring to FIG. 4, the system 400 may include a plurality of nodes (e.g., node 00 to node 44). The plurality of nodes may form (e.g., arranged to form) a network of an array structure arranged in a lattice form. In the system 400, in an example case in which the plurality of nodes form the array structure arranged in a lattice form, each node may determine a source node 410 and a destination node 420 based on a processor in the respective node. Each node may identify a position of the source node 410 and the destination node 420 based on the processor. Each node may determine, based on the processor, whether the source node 410 and the destination node 420 are positioned further inside the array than nodes (e.g., nodes 00 to 04, nodes 40 to 44, nodes 10, 20, and 30, and nodes 14, 24, and 34) arranged at edges of the array. For example, the position of the source node 410 may correspond to (xₛ, yₛ), and the position of the destination node 420 may correspond to (x_{d}, y_{d}). Also, in FIG. 4, it is assumed that xₛ<x_{d} and yₛ<y_{d}. In an example case in which the source node 410 and the destination node 420 are positioned further inside the array than the nodes arranged at the edges of the array, each node may determine a node at a reference position with respect to the source node 410 to be a first node 440. The reference position with respect to the source node 410 may be a predetermined position with respect to the source node 410. For example, each node may determine, based on the processor, a node at the position corresponding to (xₛ−1, yₛ−1) to be the first node 440. The predetermined position may be designated by a user or determined based on a position of the source node 410 on the array. For example, each node may determine the first node 440 to include a reference region (e.g., a rectangular region including the source node 410 and the destination node 420 as corner nodes) formed based on a shortest distance from the source node 410 to the destination node 420. For example, although not shown in FIG. 4, each node may determine a node (e.g., node 02) corresponding to (xₛ+1, yₛ−1) or a node (e.g., node 31) corresponding to (xₛ, yₛ+2) to be the first node 440. The first node 440 determined by each node may correspond to a corner node of the target region.

Each node may determine a node at a reference position with respect to the destination node 420 to be a second node 430. For example, each node may determine, based on the processor, a node at the position corresponding to (xd+1, yd+1) to be the second node 430. The reference position with respect to the destination node 420 may be a predetermined position with respect to the destination node 420. According to an embodiment, the predetermined position may be determined by the user as described above, or may be determined based on a position of the destination node 420 on the array. For example, each node may determine the second node 430 to include the reference region (e.g., a rectangular region including the source node 410 and the destination node 420 as corner nodes) formed based on the shortest distance from the source node 410 to the destination node 420.

Each node may determine the first node 440 and the second node 430 as corner nodes of the target region. Each node may acquire a first target region 450 including the first node 440 and the second node 430 as corner nodes, based on the processor. As another example, each node may acquire target regions (e.g., second and third target regions 460 and 470) that include a path generated based on at least one node outside the reference region (e.g., a rectangular region including the source node 410 and the destination node 420 as corner nodes). In this example, the path generated based on at least one node outside the reference region may be generated by one of the nodes included in the reference region and at least one node outside the reference region. For example, the second target region 460 may further include, compared to the reference region, not only the shortest path from the source node 410 to the destination node 420, but also a path connecting node 21 and node 31, a path connecting node 31 and node 32, and a path connecting node 32 and node 22. For example, the third target region 470 may further include, compared to the reference region, not only the shortest path from the source node 410 to the destination node 420, but also a path connecting node 12 and node 02, a path connecting node 02 and node 03, and a path connecting node 03 and node 13.

Each node may select a target node from a plurality of candidate intermediate nodes included in the target region (e.g., the first to third target regions 450, 460, and 470). In other words, each node may reduce a size of the target region for selecting the target node to a region adjacent to the source node 410 and the destination node 420 in the overall network. The system 400 may first deliver data from the source node 410 to the target node, and then deliver the data from the target node to the destination node 420. Accordingly, in an example case in which the system 400 delivers data from the source node 410 to the destination node 420 based on the selected target node, a path that deviates from the shortest path from the source node 410 to the destination node 420 may be considered. Accordingly, the system 400 may consider cases where there is high congestion on the shortest path within the reference region. The system 400 may improve data transmission rate by generating a data routing path from the source node 410 to the destination node 420, including the target node, compared to when data is transmitted only through the shortest distance.

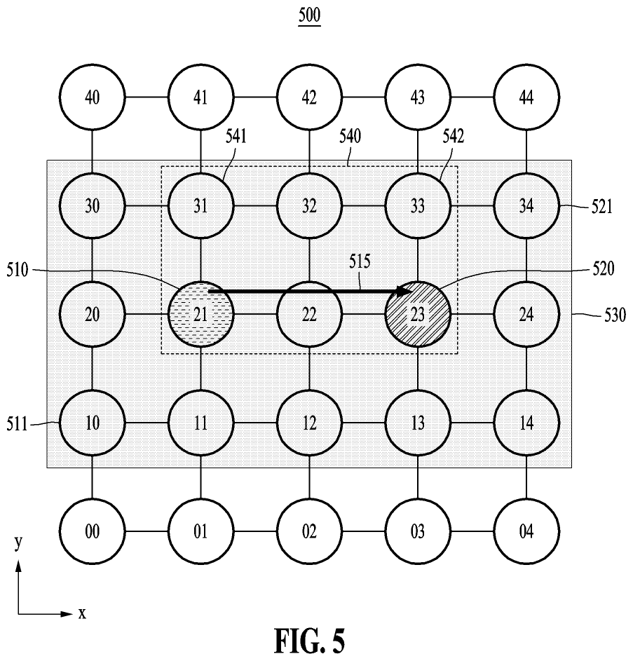

FIG. 5 is a diagram illustrating a method of acquiring a target region when a source node and a destination node are positioned inside an array structure arranged in a lattice form and are positioned on the same line of the array structure at the same time.

In a comparative example, in an array structure in which a plurality of nodes are arranged in a lattice form, when a source node 510 and a destination node 520 are arranged in a row, a target region including only nodes on the shortest path between the source node 510 and the destination node 520 may be acquired. For example, in a comparative example of FIG. 5, a target region including only the source node 510, node 22, and the destination node 520 may be acquired. Therefore, in the comparative example, when the congestion of a routing path 515 is high, the data transmission rate may be slower than when the congestion is low, by waiting for data transmission.

In the system 500 according to an embodiment, each node may acquire expanded target regions 530 and 540 compared to the comparative example. For example, in an array structure in which a plurality of nodes of the system 500 are arranged in a lattice form, each node may identify whether the source node 510 and the destination node 520 are arranged in a row along a first axis direction (e.g., an x-axis). In an example case in which the source node 510 and the destination node 520 are arranged in a row along the first axis direction (e.g., the x-axis), at least one node among nodes positioned in a second axis direction (e.g., a y-axis direction) perpendicular to the first axis direction with respect to the source node 510 may be determined as a first node 541. In other words, each node may determine a node at a position that is moved +1 in the y-axis direction from the source node 510 to be the first node 541. Additionally, each node may determine at least one node among nodes positioned in the second axis direction (e.g., the y-axis direction) with respect to the destination node 520 to be the second node 542. Each node may acquire the fourth target region 540 that includes the first node 541 and the second node 542 as corner nodes. Each node may select a target node from a plurality of candidate intermediate nodes within the fourth target region 540. The system 500 may deliver data from the source node 510 to the destination node 520 via the target node, based on the selected target node. The system 500 may avoid the influence of congestion on the routing path 515 when delivering data from the source node 510 to the destination node 520 by selecting a node other than a node on the routing path 515 within the fourth target region 540 as the target node.

In an embodiment, each node in the system 500 may determine a node 511 corresponding to (xₛ−1, yₛ−1) and a node 521 corresponding to (x_{d}+1, y_{d}+1) as corner nodes, in an example case in which the source node 510 and the destination node 520 are positioned on the same line. Each node may acquire the fifth target region 530 that includes the node 511 and node 521 as corner nodes. Each node in the system 500 may identify whether the source node 510 and the destination node 520 are arranged at an edge of the array. Each node may expand a size of the fourth target region 540 to a size of the fifth target region 530, in an example case in which the source node 510 and the destination node 520 are arranged inside the array. The system 500 may allow more data to be transferred between nodes arranged inside the array than between nodes arranged at the edges of the array. Accordingly, each node included in the system 500 may dynamically expand the size of the fourth target region 540 to the size of the fifth target region 530 based on a determination that the source node 510 and the destination node 520 are arranged inside the array.

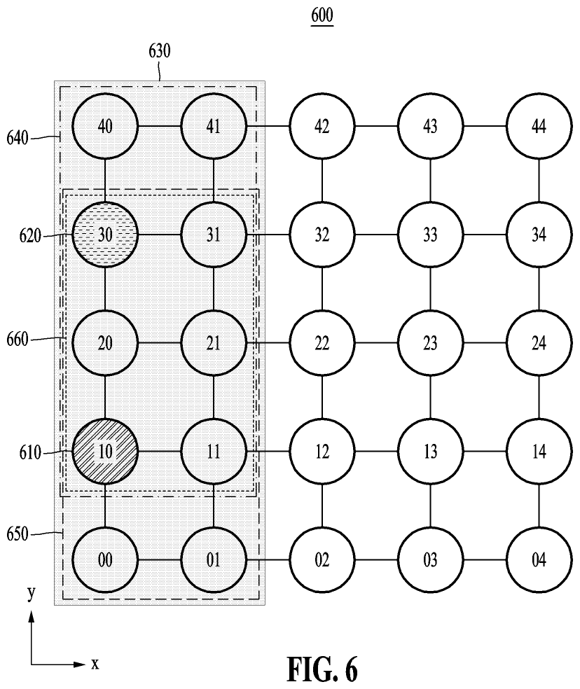

FIG. 6 is a diagram illustrating a method of acquiring a target region when a source node and a destination node are positioned at edges of an array arranged in a lattice form and are positioned on the same line of the array at the same time.

According to an embodiment, each node may identify a configuration of a plurality of nodes of the system 600. For example, each node may determine, in a network of the system 600, whether the plurality of nodes have an array structure arranged in a lattice form. According to an embodiment, based on a determination that the plurality of nodes has an array structure, each node may identify whether a source node 610 and a destination node 620 are arranged in a row along a second axis direction (e.g., a y-axis direction). In an example case in which the source node 610 and the destination node 620 are arranged in a row along the second axis direction (e.g., the y-axis direction), at least one node (e.g., node 11) among nodes positioned in a first axis direction (e.g., an x-axis direction) perpendicular to the second axis direction with respect to the source node 610 may be determined as a first node. For example, each node may determine a node at a position that is moved +1 in the x-axis direction from the source node 610 to be the first node. However, this is only an example, and the amount of movement in the x-axis direction is not limited to +1. Additionally, each node may determine at least one node (e.g., node 31) among the nodes positioned in the first axis direction (e.g., the x-axis direction) with respect to the destination node 620 to be a second node. For example, similar to the method of determining the first node, a node at a position moved +1 in the x-axis direction with respect to the destination node 620 may be determined as the second node.

Each node may acquire a sixth target region 660 that includes the first node and the second node as corner nodes. Each node may select a target node from a plurality of candidate intermediate nodes within the sixth target region 660. The system 600 may deliver data from the source node 610 to the destination node 620 via the target node, based on the selected target node.

In an embodiment, each node in the system 600 may determine a node corresponding to (1, yₛ−1) to be the first node, in an example case in which the source node 610 and the destination node 620 are positioned on the same line (e.g., a straight line in the y-axis direction) and the source node 610 is positioned at (0, yₛ). Additionally, each node may determine a node corresponding to (1, y_{d}−1) to be the second node in an example case in which the destination node 520 is positioned at (0, y_{d}). Each node included in the system 600 may determine a node corresponding to (1, yₛ−1) and a node corresponding to (1, y_{d}−1) as a corner node. Each node may acquire target regions 630, 640, 650, and 660 based on the node corresponding to (1, yₛ−1) and the node corresponding to (1, y_{d}−1). Each node in the system 600 may identify whether the source node 610 and the destination node 620 are arranged an edge of the array. Each node may reduce a size of the target regions 630, 640, 650, and 660 to a size of the sixth target region 660, in an example case in which the source node 610 and destination node 620 are arranged at the edge of the array. The nodes arranged at the edge of the array in the system 600 may transmit less data than nodes arranged inside the array. Accordingly, in an example case in which each node included in the system 600 identifies that the source node 610 and the destination node 620 are arranged at the edge of the array, the size of the target regions 630, 640, 650, and 660 may be reduced to the size of the sixth target region 660 corresponding to the smallest size.

In summary, a plurality of nodes included in the systems 500 and 600 according to an embodiment may adjust a size of a target region based on a predetermined threshold size, based on positions of a source node (e.g., the source nodes 510 and 610 of FIGS. 5 and 6) and a destination node (e.g., the destination nodes 520 and 620 of FIGS. 5 and 6). For example, as illustrated in FIG. 5, in an example case in which the source node 510 and the destination node 520 are positioned further inside the array than the nodes arranged at the edge of the array, the plurality of nodes in FIG. 5 may adjust a size of the fourth target region 540 to a size of the fifth target region 530 that is larger than a predetermined threshold size. Accordingly, the plurality of nodes in FIG. 5 may increase the size of a target region for selecting a target node by considering that the amount of data movement is greater when the source node 510 and destination node 520 are positioned inside the array than when the source node 510 and destination node 520 are positioned at the edge of the array. As another example, as illustrated in FIG. 6, in an example case in which the source node 610 and the destination node 620 are arranged at the edge of the array, the plurality of nodes in FIG. 6 may reduce a size of the target region 630 to less than a predetermined threshold size. In FIG. 6, the plurality of nodes may acquire one of the smaller target regions 640, 650, or 660 as a region for selecting a target node by reducing the size of the target region 630 to a size smaller than a predetermined threshold size. FIG. 6 shows that the target region may be acquired by considering that the amount of data movement at the edge of the array is less than the amount of data movement inside the array.

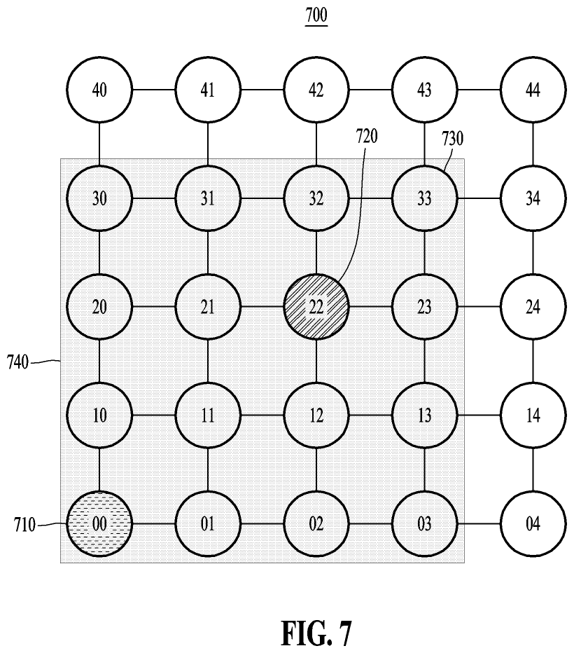

FIG. 7 is a diagram illustrating a method of acquiring a target region when at least one of a source node and a destination node is positioned at a corner in an array in which a plurality of nodes are arranged in a lattice form.

According to an embodiment, a plurality of nodes in a system 700 may correspond to a network having an array structure arranged in a lattice form. For example, in an example case in which the plurality of nodes included in the system 700 correspond to an array structure arranged in a lattice form, each node may identify a position of a source node 710 and a destination node 720. For example, based on a determination that at least one of the source node 710 and destination node 720 identified by each node is positioned at a corner of the array of the system 700, each node may determine a node positioned at a corner to be a first node. For example, referring to FIG. 7, the source node 710 is positioned at a corner of the network array of the system 700, and the destination node 720 is positioned inside the network array. Therefore, each node may determine the source node 710 to be the first node. Each node may determine a node arranged in a predetermined position based on another node (e.g., the destination node 720 of FIG. 7) that is not positioned at a corner to be a second node 730. In an example case in which a position of the destination node 720 is (xd, yd), the predetermined position may correspond to (xd+1, yd+1). Each node may acquire a target region 740 that includes a first node (e.g., the source node 710) and the second node 730 as corner nodes. Each node in the system 700 may determine a target node within the target region 740. Although FIG. 7 illustrates the target region 740 of one size, the size of the target region 740 may change depending on which node each node determines as the second node 730 in the network array.

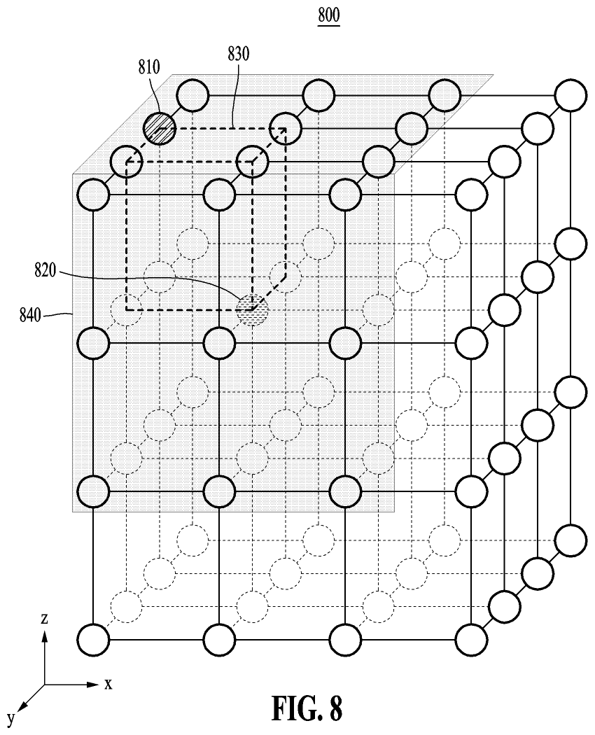

FIG. 8 is a diagram illustrating a method of acquiring a target region when a plurality of nodes of a system form a three-dimensional (3D) network structure, according to an embodiment.

According to an embodiment, a system 800 may include a plurality of nodes. The plurality of nodes may form a 3D network structure in the system 800. For example, the plurality of nodes may form a 3D lattice network structure in the system 800. Each node may determine a source node 810 and a destination node 820 based on a processor. Each node may determine a reference region 830 based on a shortest path from the source node 810 to the destination node 820. Each node may acquire a target region 840 that includes nodes included in the reference region 830 and at least one node outside the reference region 830. A detailed method by which each node acquires the target region 840 has been described above with reference to FIGS. 4 to 7, and thus, a repeated discussion related thereto is omitted. Each node may select a target node from candidate intermediate nodes included in the target region 840. In other words, each node may select a target node from the target region 840 that is smaller than the region that includes all of the plurality of nodes included in the system 800. The source node 810 in the system 800 may deliver data originating from the source node to a selected target node through a shortest distance. For example, the source node 810 may deliver data to the target node via a path corresponding to a minimum hop count. Thereafter, the target node may transmit the data received from the source node 810 to the destination node 820 via the shortest distance.

One or more embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter. The above-described hardware devices may be configured to act as one or more software modules in order to perform the operations of the above-described examples, or vice versa.

Although the embodiments have been described with reference to the limited drawings, one of ordinary skill in the art may apply various technical modifications and variations based thereon. For example, suitable results may be achieved if the described techniques are performed in a different order, and/or if components in a described system, structure, device, or circuit are combined in a different manner, and/or replaced or supplemented by other components or their equivalents.

Therefore, other implementations, other embodiments, and equivalents to the claims are also within the scope of the following claims.

What is claimed is:

1. A method of routing data in a network, the method comprising:
determining, from among a plurality of nodes in the network, a source node and a destination node, the source node configured to transmit data and the destination node configured to receive the data from the source node;
acquiring a target region comprising nodes of a reference region, among the plurality of nodes, the reference region determined based on a shortest path from the source node to the destination node and at least one node outside the reference region;
transmitting the data originating from the source node to a target node selected from candidate intermediate nodes in the target region; and
transmitting the data originating from the source node to the destination node from the target node.

2. The method of claim 1, wherein the acquiring of the target region comprises:
identifying the reference region, based on a position of the source node and the destination node in the network; and
acquiring the target region comprising a path generated based on the at least one node outside the reference region.

3. The method of claim 1, wherein the acquiring of the target region comprises:
in an array in which the plurality of nodes are arranged in a lattice form, determining a node at a first position with respect to the source node to be a first node, based on the source node and the destination node being positioned further inside the array than nodes arranged at an edge of the array;
determining a node at a second position with respect to the destination node to be a second node; and
acquiring the target region comprising the first node and the second node.

4. The method of claim 1, wherein the acquiring of the target region comprises:
in an array in which the plurality of nodes are arranged in a lattice form, based on the source node and the destination node being arranged in a row along a first axis direction, determining at least one node among nodes positioned in a second axis direction perpendicular to the first axis direction with respect to the source node to be a first node;
determining at least one node among the nodes positioned in the second axis direction with respect to the destination node to be a second node; and
acquiring the target region comprising the first node and the second node.

5. The method of claim 1, wherein the acquiring of the target region comprises:
in an array in which the plurality of nodes are arranged in a lattice form, based on one of the source node or the destination node being positioned at a corner of the array, determining a node positioned at the corner to be a first node;
determining a node arranged at a first position other than the node positioned at the corner among the source node or the destination node to be a second node; and
acquiring the target region comprising the first node and the second node.

6. The method of claim 1, wherein the acquiring of the target region comprises:
in an array in which the plurality of nodes are arranged in a lattice form, determining whether at least one of the source node and the destination node is positioned at an edge of the array;
based on at least one of the source node and the destination node being positioned at an edge of the array, acquiring a target region smaller than a threshold size; and
based on the source node and the destination node being positioned inside the edge of the array, acquiring a target region larger than the threshold size.

7. The method of claim 1, wherein the transmitting of the data originating from the source node to the selected target node comprises:
transmitting information about the target region to the candidate intermediate nodes comprised in the target region; and
selecting the target node from the candidate intermediate nodes comprised in the target region, based on the information about the target region.

8. The method of claim 7, wherein the selecting of the target node comprises:
measuring congestions on data movement paths corresponding to each of the candidate intermediate nodes comprised in the target region; and
selecting a candidate intermediate node corresponding to a lowest congestion among the measured congestions as the target node.

9. The method of claim 1, wherein the determining of the source node and the destination node comprises:
acquiring address information corresponding to a position of the source node; and
acquiring address information corresponding to a position of the destination node.

10. The method of claim 1, wherein the transmitting of the data originating from the source node to the target node comprises:
transmitting the data from the source node to the target node via a first shortest path corresponding to a minimum hop count, and
wherein the transmitting of the data from the target node to the destination node comprises:
transmitting the data from the target node to the destination node via a second shortest path corresponding to a minimum hop count.

11. The method of claim 1, wherein the transmitting of the data originating from the source node to the target node comprises:
determining whether a node to receive the data is positioned inside the target region; and
based on the node to receive the data being positioned inside the target region, transmitting the data originating from the source node to the node to receive the data.

12. A non-transitory computer-readable storage medium storing one or more executable program instructions,
wherein the one or more executable program instructions, when executed by a computing system, configured to cause the computing system to:
determine, from among a plurality of nodes in a network, a source node and a destination node, the source node configured to transmit data and the destination node configured to receive the data from the source node,
acquire a target region comprising nodes of a reference region, among the plurality of nodes, the reference region determined based on a shortest path from the source node to the destination node and at least one node outside the reference region,
transmit the data originating from the source node to a target node selected from candidate intermediate nodes in the target region, and
transmit the data originating from the source node to the destination node from the target node.

13. A system for routing data, comprising:
a plurality of nodes in a network,
wherein at least one node of the plurality of nodes comprises:
memory storing a plurality of instructions;
a switch; and
a processor for executing the plurality of instructions and determining a port to transmit data through the switch,
wherein the processor is configured to:
determine, from among the plurality of nodes, a source node and a destination node, the source node configured to transmit data and the destination node configured to receive the data from the source node,
acquire a target region comprising nodes of a reference region, among the plurality of nodes, the reference region determined based on a shortest path from the source node to the destination node and at least one node outside the reference region,
transmit the data originating from the source node to a target node selected from candidate intermediate nodes in the target region, and
transmit the data originating from the source node to the destination node from the target node.

14. The system of claim 13, wherein the processor is further configured to:
identify the reference region, based on a position of the source node and the destination node in the network, and
acquire the target region comprising a path generated based on the at least one node outside the reference region.

15. The system of claim 13, wherein the processor is further configured to:
in an array in which the plurality of nodes are arranged in a lattice form, determine a node at a first position with respect to the source node to be a first node, based on the source node and the destination node being positioned further inside the array than nodes arranged at an edge of the array,
determine a node at a second position with respect to the destination node to be a second node, and
acquire the target region comprising the first node and the second node.

16. The system of claim 13, wherein the processor is further configured to:
in an array in which the plurality of nodes are arranged in a lattice form, based on the source node and the destination node being arranged in a row along a first axis direction, determine at least one node among nodes positioned in a second axis direction perpendicular to the first axis direction with respect to the source node to be a first node,
determine at least one node among the nodes positioned in the second axis direction with respect to the destination node to be a second node, and
acquire the target region comprising the first node and the second node.

17. The system of claim 14, wherein the processor is further configured to:
in an array in which the plurality of nodes are arranged in a lattice form, based on one of the source node or the destination node being positioned at a corner of the array, determine a node positioned at the corner to be a first node,
determine a node arranged at a first position other than the node positioned at the corner among the source node or the destination node to be a second node, and
acquire the target region comprising the first node and the second node.

18. The system of claim 14, wherein the processor is further configured to:
in an array in which the plurality of nodes are arranged in a lattice form, determine whether at least one of the source node and the destination node is positioned at an edge of the array,
based on at least one of the source node and the destination node being positioned at an edge of the array, acquire a target region smaller than a predetermined threshold size, and
based on the source node and the destination node being positioned inside the edge of the array, acquire a target region larger than the predetermined threshold size.

19. The system of claim 14, wherein the processor is further configured to:
transmit information about the target region to the candidate intermediate nodes comprised in the target region, and select the target node from the candidate intermediate nodes comprised in the target region, based on the information about the target region.

20. The system of claim 19, wherein the processor is further configured to:
measure congestions on data movement paths corresponding to each of the candidate intermediate nodes comprised in the target region, and select a candidate intermediate node corresponding to a lowest congestion among the measured congestions as the target node.
